(19) United States
(12) Patent Application Publication
(10) Pub. No.: US 2005/0120144 A1
(43) Pub. Date: Jun. 2, 2005

(54) Disk control unit, disk drive, disk control method, and disk control program

(75) Inventor: Kenji Koyama, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 10/804,588

(22) Filed: Mar. 19, 2004

(30) Foreign Application Priority Data
Jul. 7, 2003 (JP) 2003-192706

(51) Int. Cl. G06F 13/10

(52) U.S. Cl. 710/8

(57) ABSTRACT

A disk drive is capable of reducing power consumption by changing an operation clock used by the disk drive in accordance with the condition of data transfer. The disk drive includes an HDC (2) for setting the operation clock and controlling writing and reading based on a transfer command, an interface (1) for inputting and outputting data from and to a host device, a memory (3) for temporarily holding data, and a PLL (5) for changing an operation clock used by the HDC (2), the interface (1) and the memory (3) based on a setting of the operation clock, a recording medium (12) for holding data, a read and write part for writing data into the recording medium (12) or reading data from the recording medium (12), and a mechanism for controlling the recording medium (12) and the head (11).

### BACKGROUND OF THE INVENTION

1. Field of the Invention

The present invention relates to a disk control unit, a disk control method, a disk control program, and a disk drive with such a disk control unit installed thereon, which are designed to reduce power consumption at the time when data is written into and read from the disk drive.

2. Description of the Related Art

At first, a magnetic disk drive will be described as one example of a known disk drive. FIG. 4 is a block diagram showing one example of the configuration of such a known magnetic disk drive and a host device such as a host computer. As shown in FIG. 4, the known magnetic disk drive, generally designated at 30, includes an interface 1, an HDC (Hard Disk Controller) 2, a memory 3, an oscillator 4, a PLL (Phase Locked Loop) 5, a rotation control part 6, and a position control part 7, an R/W (Read/Write) control part 8, a recording medium drive part 9, a head drive part 10, a head 11, and a recording medium 12. The interface 1 communicates with the host device, designated at 40, by using a communication method such as an ATA (AT Attachment) method, a SCSI (Small Computer System Interface) method, etc.

Now, reference will be made to the outline operation of the known magnetic disk drive 30. The magnetic disk drive 30 writes the data input from the host device 40 into the recording medium 12, reads data from the recording medium 12, and outputs it to the host device 40, in accordance with control commands input thereto from the host device 40. The interface 1 inputs and outputs data, control commands and the like from and to the host device 40. The HDC 2 controls the entire magnetic disk drive 30 in accordance with a firmware or the like. The memory 3 temporarily holds data. The oscillator 4 generates an operation clock reference signal to the PLL 5, where operation clocks are generated from the reference signal. The rotation control part 6 controls the recording medium drive part 9 so that the recording medium 12 is driven to rotate under the control of the rotation control part 6. The position control part 7 moves the head 11 by controlling the head drive part 10. The R/W control part 8 writes and reads data into and from the recording medium 12 by controlling the head 11.

The magnetic disk drive 30 has four states including an active state (Active), an idle state (Idle), a stand-by state (Stand-by) and a sleep state (Sleep), and it is in the active state until it receives either one of “Idle”, “Stand-by” and “Sleep” commands, which are power saving commands, from the host device 40 in the course of data transfer and after the termination of data transfer.

First of all, reference will be made to the case where the magnetic disk drive 30 receives an idle command from the host device 40 after the termination of data transfer. In this case, the magnetic disk drive 30 is changed into its idle state under the control of the HDC 2. In the idle state, the magnetic disk drive 30 can receive commands, and the recording medium drive part 9 is in operation, so the magnetic disk drive 30 can return to its active state at any time.

Next, reference will be made to the case where the magnetic disk drive 30 receives a stand-by command after the termination of data transfer or in the idle state. In this case, the magnetic disk drive 30 is changed into the stand-by state under the control of the HDC 2. In the stand-by state, the magnetic disk drive 30 can receive commands, but the recording medium drive part 9 is stopped, so it takes a longer spin-up time for the magnetic disk drive 30 to return to its active state.

Then, reference will be made to the case where the magnetic disk drive 30 receives a sleep command after the termination of data transfer or in the idle state or in the stand-by state. In this case, the magnetic disk drive 30 is changed into its sleep state under the control of the HDC 2. In the sleep state, the magnetic disk drive 30 can not receive commands. In order for the magnetic disk drive 30 to return to its active state, it is necessary to perform a host-reset or to turn off and on the power supply again. The No. 39 bus among the forty ATA buses is for host-reset, and a host-reset operation is effected when the host device 40 drives this line or bus into a low level.

Next, reference will be made to operation clocks used in the magnetic disk drive 30. The interface 1, the HDC 2, the memory 3, the rotation control part 6, the position control part 7 and the R/W control part 8 operate in accordance with operation clocks supplied from the PLL 5. Here, note that the frequency of an operation clock that is used by the rotation control part 6, the position control part 7 and the R/W control part 8 is fixed, whereas the frequency of an operation clock that is used by the interface 1, the HDC 2 and the memory 3 is variable.

In the known magnetic disk drive 30, the HDC 2 monitors power saving commands such as “Idle”, “Stand-by”, “Sleep” and the like issued by the host device 40, and sets an operation clock corresponding to a detected power saving command in the PLL 5. The PLL 5 supplies the operation clock thus set to the interface 1, the HDC 2 and the memory 3, whereby the frequency of the operation clock used by the interface 1, the HDC 2 and the memory 3 is made to change or stop.

However, the operation clock used by the interface 1, the HDC 2 and the memory 3 during the reading and writing of data has always the highest frequency, and hence there arises a problem in that the maximum electric power is consumed regardless of the condition of data transfer.

### SUMMARY OF THE INVENTION

Accordingly, the present invention has been made in view of the above-mentioned problem, and has for its object to provide a disk control unit, a disk drive control method, a disk drive control program and a disk drive with such a disk control unit installed thereon, in which power consumption can be reduced by changing an operation clock used by the disk drive in accordance with the condition of data transfer.

In order to solve the above-mentioned problem, according to one aspect of the present invention, there is provided a disk control unit for controlling a disk drive in accordance with a transfer command received from a host device, the disk control unit comprising: a clock control part that sets an operation clock used by the disk drive based on the transfer command; and a disk control part that controls writing and reading based on the transfer command.

Preferably, in the disk control unit according to the present invention, the transfer command includes an instruction for writing or reading data, a transfer mode, and a transfer rate.

According to such a configuration, the disk drive can use an operation clock corresponding to the condition of data transfer, so that the power consumption of the disk drive can be reduced in the course of reading or writing data. Here, in one embodiment of the present invention, the disk control part comprises an HDC 20.

Preferably, in the disk control unit according to the present invention, the clock control part selects the value of a minimum operation clock required to execute the transfer command.

According to such a configuration, the disk drive can use the minimum or lowest operation clock, whereby power consumption of the disk drive can be reduced during reading or writing data.

According to another aspect of the present invention, there is provided a disk drive for writing and reading data in accordance with a transfer command received from a host device, the disk drive comprising: the above-mentioned disk control unit; an interface that inputs and outputs data from and to the host device; a memory that temporarily holds the data; an operation clock generation part that changes an operation clock used by the disk control unit, the interface and the memory based on a setting of the operation clock; a recording medium that holds data; a read and write part that writes data into the recording medium or reads data from the recording medium; and a mechanism that controls the position of writing or reading in the recording medium.

Here, in one embodiment, the interface comprises an interface 1. The memory comprises a memory 3. The operation clock generation part comprises an oscillator 4 and a PLL 5. The recording medium comprises a recording medium 12. The read and write part comprises an R/W control part 8 and a head 11. The mechanism comprises a rotation control part 6, a position control part 7, a recording medium drive part 9 and a head drive part 10.

According to a further aspect of the present invention, there is provided a disk control method for controlling a disk drive in accordance with a transfer command received from a host device, the method comprising the steps of: setting an operation clock used by the disk drive based on the transfer command; and controlling writing and reading based on the transfer command.

Preferably, in the disk control method according to the present invention, the transfer command includes an instruction for writing or reading data, a transfer mode, and a transfer rate.

Preferably, in the disk control method according to the present invention, the setting is to select the value of a minimum operation clock required to execute the transfer command.

According to a still further aspect of the present invention, there is provided a disk control program stored in a medium, which can be read by a computer, so as to make the computer implement a disk control method for controlling a disk drive in accordance with a transfer command received from a host device, the program being operable to make the computer perform the steps comprising: setting an operation clock used by the disk drive based on the transfer command; and controlling writing and reading based on the transfer command.

Preferably, in the disk control program according to the present invention, the transfer command include an instruction for writing or reading data, a transfer mode, and a transfer rate.

Preferably, in the disk control program according to the present invention, the setting is to select the value of a minimum operation clock required to execute the transfer command.

Here, note that in the above disk control program, the computer readable recording medium includes, in addition to a semiconductor memory such as a ROM, a RAM and the like, a portable storage medium such as a CD-ROM, a flexible disk, a DVD disk, a magneto-optical disk, an IC card or the like, or a database that holds therein computer programs, or another computer and its database, or a transmission medium on a communication line.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing one example of the configuration of a magnetic disk drive and a host device according to one embodiment of the present invention.

FIG. 2 is a table showing a list of transfer modes in an ATA interface.

FIG. 3 is a flow chart showing one example of the control processing of an operation clock upon receipt of a transfer command.

FIG. 4 is a block diagram showing one example of the configuration of a known magnetic disk drive and a host device.

### DESCRIPTION OF THE PREFERRED EMBODIMENT

Hereinafter, preferred embodiments of the present invention will be described in detail while referring to the accompanying drawings. In this embodiment, reference will be made, by way of example only, to the case where a magnetic disk drive and an ATA interface are used as a disk drive and an interface, respectively.

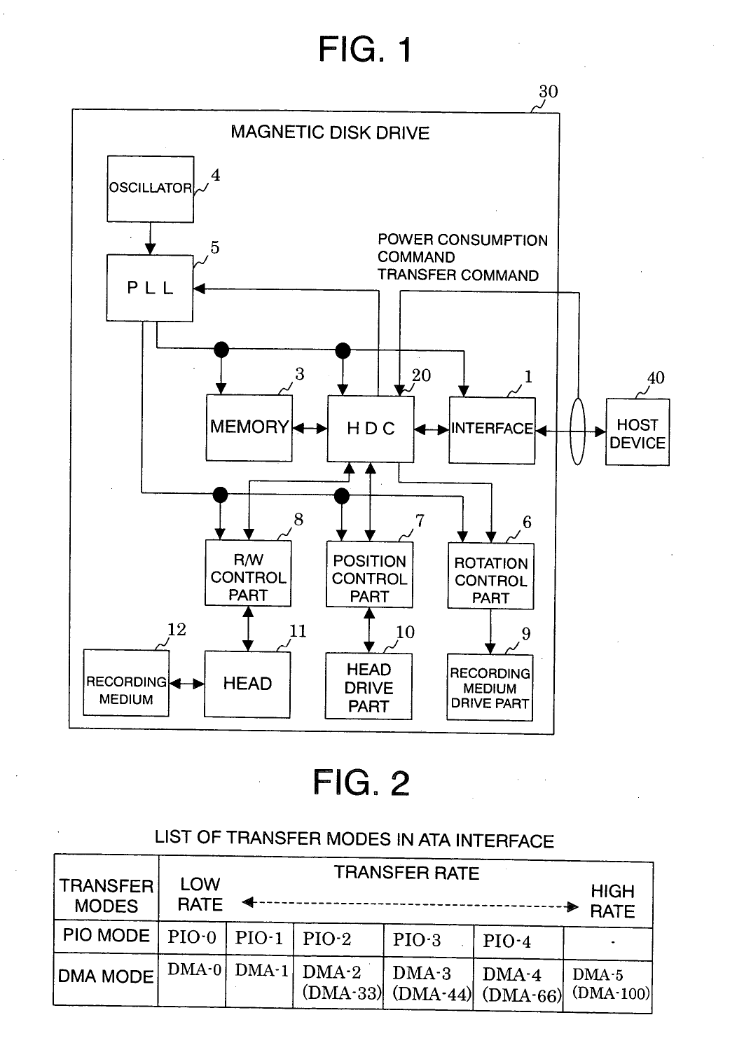

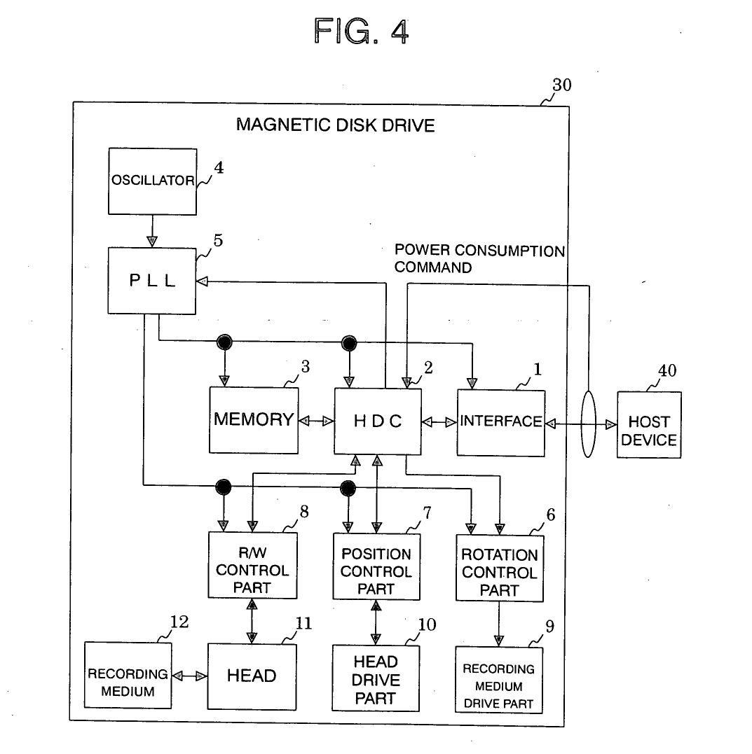

FIG. 1 is a block diagram that shows one example of the configuration of a magnetic disk drive and a host device according to one embodiment of the present invention. In FIG. 1, blocks with the same symbols as those in FIG. 4 represent the same ones as the blocks shown in FIG. 4, and hence an explanation thereof is omitted. The magnetic disk drive, generally designated at 30, in this embodiment is provided with an HDC 20 in place of the HDC 2. The HDC 20 has the function similar to that of the known HDC 2, but further monitors a transfer command in addition to power saving commands issued from the host device 40, and sets an operation clock of the minimum or lowest frequency necessary to execute the transfer command thus detected to the PLL 5. The PLL 5 supplies the operation clock thus set to the interface 1, the HDC 20 and the memory 3. The transfer command includes an instruction for writing or reading data, a transfer mode and a transfer speed or rate.

FIG. 2 is a table illustrating a list of transfer modes in the ATA interface. The transfer modes include two kinds, PIO (Programmed I/O) and DMA (Direct Memory Access). The transfer rate of the PIO mode is represented by PIO-0 through PIO-4, and the transfer rate of the DMA mode is represented by DMA-0 through DMA-5. The greater the value of the figure attached to each PIO or DMA, the higher does the transfer rate thereof become. At the time of writing and reading data, the host device 40 first issues a command “Set Feature 03 xx”, and then one of commands comprising “Read PIO”, “Write PIO”, “Read DMA” and “Write DMA”. Here, note that the command “Set Feature 03 xx” indicates that the transfer mode is to be changed, and the transfer mode and the transfer rate are specified by “xx” in this command. The commands “Read PIO”, “Write PIO”, “Read DMA” and “Write DMA” indicate instructions for writing or reading in the PIO and DMA modes, respectively, and the operation of writing or reading data in each mode is started by these commands.

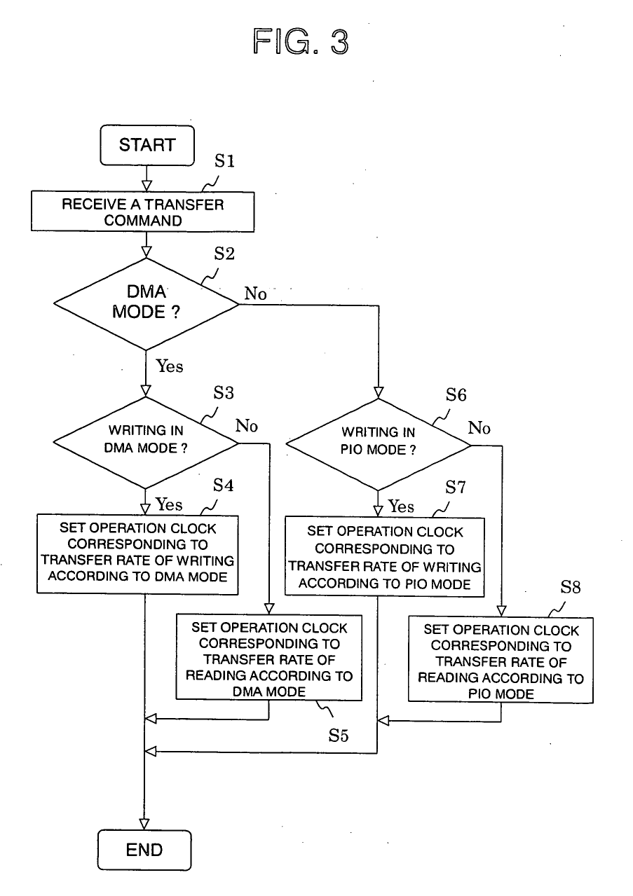

Next, reference will be made to the control of an operation clock upon receipt of a transfer command by the HDC 20 while using a control flow shown in FIG. 3. First of all, upon receipt of a transfer command from the host device 40 (S1), the HDC 20 determines whether the transfer mode is the DMA mode or the PIO mode (S2). If the transfer mode is the DMA mode (S2, Yes), it is further determined whether it is writing or reading according to the DMA mode (S3). If it is writing according to the DMA mode (S3, Yes), an operation clock corresponding to the transfer rate of writing according to the DMA mode is set into the PLL 5 (S4), and this flow is ended. If it is reading according to the DMA mode (S3, No), an operation clock corresponding to the transfer rate of reading according to the DMA mode is set into the PLL 5 (S5), and this flow is ended.

On the other hand, if the transfer mode is not the DMA mode but the PIO mode (S2, No), it is determined whether it is writing or reading according to the PIO mode (S6). If it is writing according to the PIO mode (S6, Yes), an operation clock corresponding to the transfer rate of writing according to the PIO mode is set into the PLL 5 (S7), and this flow is ended. If it is reading according to the PIO mode (S6, No), an operation clock corresponding to the transfer rate of reading according to the PIO mode is set into the PLL 5 (S8), and this flow is ended.

For example, when data is read in the DMA-4 mode, a command “Set Feature 03 44” is first issued from the host device 40, and a command “Read DMA” is then issued. Based on a transfer command comprising these two commands, the HDC 20 makes a determination that it is an instruction for reading in the DMA-4 mode, and sets an appropriate operation clock for reading in the DMA-4 mode.

In addition, when data is written in the PIO-4 mode for example, a command “Set Feature 03 OC” is first issued from the host device 40, and a command “Write PIO” is then issued. Based on a transfer command comprising these two commands, the HDC 20 makes a determination that it is an instruction of writing in the PIO-4 mode, and sets an appropriate operation clock for writing in the PIO-4 mode.

Although in this embodiment, description has been made taking the ATA interface as an example, the present invention can be applied in other interfaces such as a SCSI interface, etc. Moreover, although in this embodiment, the magnetic disk drive has been taken as an example of the disk drive, the present invention can be applied in other disk drives such as an optical disk drive, etc.

As described above in detail, according to the present invention, it is possible to reduce power consumption by setting an operation clock necessary for executing a transfer command issued from a host device such as a host computer. For example, in the case of an ATA interface, the transfer rate of the DMA-5 mode is 100 Mbytes/s, and the transfer rate of the DMA-2 mode is 33.3 Mbytes/s, and hence it is satisfactory that the operation clock in the DMA-2 mode is set to be 33% assuming that the operation clock in the DMA-5 mode is 100%. In this manner, the operation clock and the power consumption for the inventive disk drive has a proportional relation, so it becomes possible to operate the disk drive with a smaller amount of power consumption when the transfer mode is low, as compared with conventional disk drives.

While the invention has been described in terms of a preferred embodiment, those skilled in the art will recognize that the invention can be practiced with modifications within the spirit and scope of the appended claims.

1. A disk control unit for controlling a disk drive in accordance with a transfer command received from a host device, said disk control unit comprising:
a clock control part that sets an operation clock used by said disk drive based on said transfer command; and
a disk control part that controls writing and reading based on said transfer command.

2. The disk control unit as set forth in claim 1, wherein said transfer command includes an instruction for writing or reading data, a transfer mode, and a transfer rate.

3. The disk control unit as set forth in claim 2, wherein said clock control part selects the value of a minimum operation clock required to execute said transfer command.

4. A disk drive for writing and reading data in accordance with a transfer command received from a host device, said disk drive comprising:
a disk control unit as set forth in claim 1;
an interface that inputs and outputs data from and to said host device;
a memory that temporarily holds the data;
an operation clock generation part that changes an operation clock used by said disk control unit, said interface and said memory based on a setting of said operation clock;
a recording medium that holds data;
a read and write part that writes data into said recording medium or reads data from said recording medium; and
a mechanism that controls the position of writing or reading in said recording medium.

5. A disk control method for controlling a disk drive in accordance with a transfer command received from a host device, said disk control method comprising the steps of:
setting an operation clock used by said disk drive based on said transfer command; and
controlling writing and reading based on said transfer command.

6. The disk control method as set forth in claim 5, wherein said transfer command includes an instruction for writing or reading data, a transfer mode, and a transfer rate.

7. The disk control method as set forth in claim 6, wherein said setting is to select the value of a minimum operation clock required to execute said transfer command.

8. A disk control program for making a computer implement a disk control method for controlling a disk drive in accordance with a transfer command received from a host device, said disk control program being operable to make said computer perform the steps comprising:
setting an operation clock used by said disk drive based on said transfer command; and
controlling writing and reading based on said transfer command.

9. A disk control program as set forth in claim 8, wherein said transfer command include an instruction for writing or reading data, a transfer mode, and a transfer rate.

10. The disk control program as set forth in claim 9, wherein said setting is to select the value of a minimum operation clock required to execute said transfer command.
